(19) United States
(12) Patent Application Publication
(10) Pub. No.: US 2008/0013012 A1
(43) Pub. Date: Jan. 17, 2008

(54) Posioning assembly of liquid crystal display

(76) Inventor: Wen-Pin Cheng, Taipei Hsien (TW)

Correspondence Address: WEN-PIN CHENG, 235 Chung-Ho, Box 8-24, Taipei, omitted

(21) Appl. No.: 11/487,123

(22) Filed: Jul. 17, 2006

(51) Int. Cl. G02F 1/1333

(52) U.S. Cl. 349/60

(57) ABSTRACT

A positioning assembly of a liquid crystal display is disclosed. The positioning assembly is installed upon a bottom plate. The positioning assembly has a protrusion. One end surface of the protrusion has an axial hole. A periphery of the axial hole is formed with an annular shoulder. An inner side of the shoulder near the axial hole is formed with an annular cut portion for guiding a screw element into the axial hole. The annular cut portion is an inclined surface; and a lower edge of the inclined surface is near the axial hole. The protrusion has a tapered shape or an L shape.

### FIELD OF THE INVENTION

The present invention relates to liquid crystal displays, in particular to a positioning assembly of a liquid crystal display, wherein the positioning assembly has a protrusion which has no threaded hole so that the defect in the prior art can be avoided. Thereby the yield rate is increased. Furthermore, the parts can be assembled correctly.

### BACKGROUND OF THE INVENTION

Referring to FIG. 1, the retainer of a computer (or a mainframe of an electronic device) is illustrated. The retainer 10 is a copper post 10 which is stand upon a bottom plate 12. It is difficult to combine the copper post 10 and the bottom plate 12. Many ways are used to combine the two. Firstly, the inner side of the copper post 10 is formed with threaded hole 14. The bottom plate 12 is formed with a via hole 16. The two components are riveted. Moreover, a reverse buckle can be used to enhance the combination of the two. However there are many steps being used. The cost is high and manufacturing time is long.

Referring to FIG. 2, another prior art way is illustrated. The retainer 2 has a bottom plate 22. A protrusion 20 is formed on the bottom plate 22. Then the bottom plate 20 is formed with a threaded hole 24. There are many protrusions 20 are formed on the bottom plate 22. Although the protrusions can be integrally formed with the bottom plate 22, the thread holes must be formed one by one. The working time is long. If one protrusion is destroyed in forming the thread, the whole bottom plate 22 must be deserted. Thus, the work must be done very carefully. Thereby after finished the threaded holes, all the protrusions must be checked, if any one of the protrusions is not perfect, the bottom plate must be deserted. Thus the yield rate is low and a great number of bottom plates must be deserted. It is not economic.

### SUMMARY OF THE INVENTION

Accordingly, the primary object of the present invention is to provide a positioning assembly of a liquid crystal display, wherein the positioning assembly has a protrusion which has no threaded hole so that the defect in the prior art can be avoided. Thereby the yield rate is increased. Furthermore, the parts can be assembled correctly.

To achieve above object, the present invention provides a positioning assembly of a liquid crystal display. The positioning assembly is installed upon a bottom plate. The positioning assembly has a protrusion. One end surface of the protrusion has an axial hole. A periphery of the axial hole is formed with an annular shoulder. An inner side of the shoulder near the axial hole is formed with an annular cut portion for guiding a screw element into the axial hole. The annular cut portion is an inclined surface; and a lower edge of the inclined surface is near the axial hole. The protrusion has a tapered shape or an L shape.

The various objects and advantages of the present invention will be more readily understood from the following detailed description when read in conjunction with the appended drawing.

### BRIEF DESCRIPTION OF THE DRAWINGS

FIG. 1 is a structural cross sectional view of a prior art copper post.

FIG. 2 is a cross sectional view of a prior art positioning assembly.

FIG. 3 shows the prior art bottom plate for positioning parts.

FIG. 4 is a perspective view of the first embodiment of the present invention.

FIG. 5 is a cross sectional view of the first embodiment of the present invention.

FIG. 6 is a perspective view of the second embodiment of the present invention.

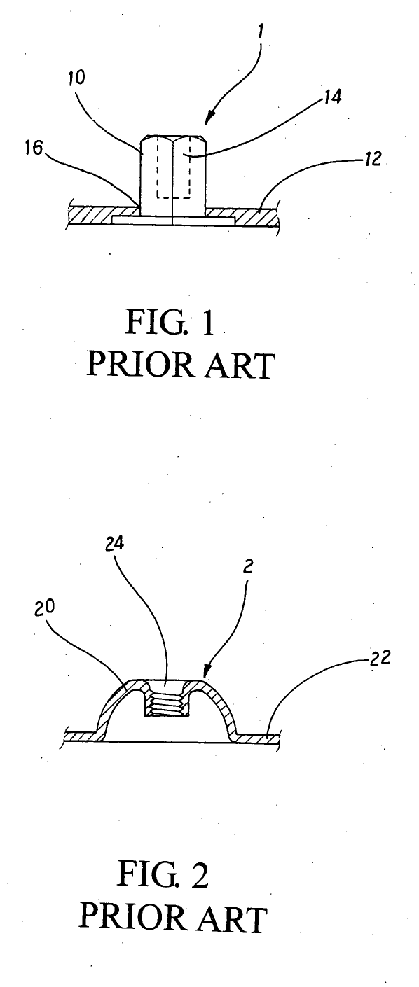

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

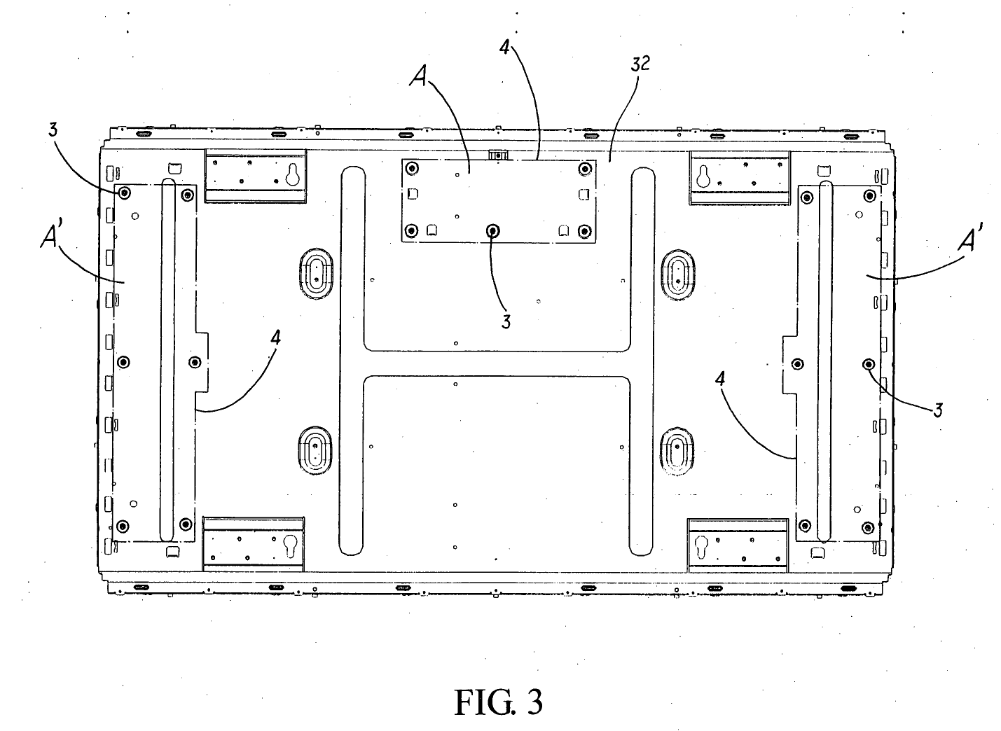

Referring to FIG. 3, the positioning assembly 3 of a liquid crystal display is illustrated. The positioning assembly 3 is located upon a bottom plate 32 which is a part of a liquid crystal display. A plurality of parts are be locked to the bottom plate 32 by screws. For example, the area A is screwed with a circuit board and the area A′ serves to screw with a speaker, an electronic control module, or other related electronic parts. The positioning assembly 3 can be formed by punching, preferably by a one time continuous punching.

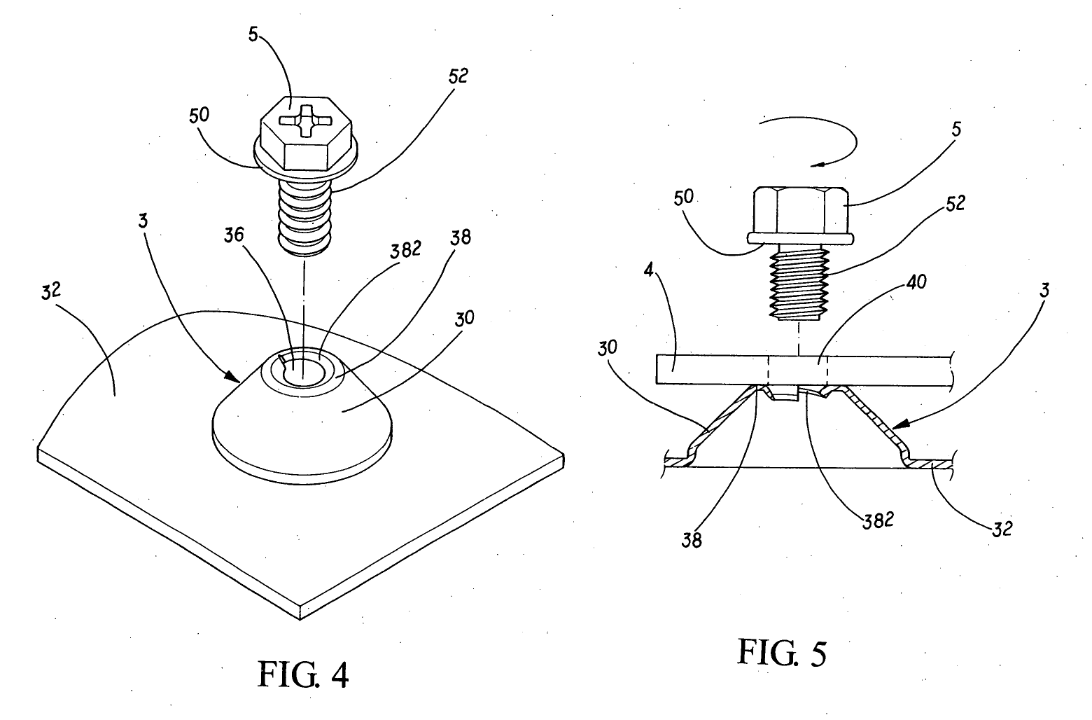

With reference to FIG. 4, the positioning assembly 3 can be formed by punching, extrusion, etc. In this embodiment, the positioning assembly 3 has a tapered shape. The positioning assembly 3 has a protrusion 30. One end surface 34 of the protrusion 30 has an axial hole 36 at a central portion thereof. A periphery of the axial hole 36 is formed with an annular shoulder 38. An inner edge of the shoulder 38 around the axial hole 36 is formed as an annular cut portion 382 which is an inclined surface with a lower edge near the axial hole 36 so as to guide a screw element 5 into the axial hole 36.

By the positioning assembly 3, the bottom plate 32 can lock with other part 4, such as a circuit board. With reference to FIGS. 4 and 5, in assembly, the via hole 40 of the part 4 is aligned to the positioning assembly 3. The screw element 5 passes through the via hole 40 of the part 4 and then is guided by the annular cut portion 382, the screw element 5 is screwed into the axial hole 36. When the resisting portion 50 of the screw element 5 is in contact with the part 4, a thread 52 is engaged to the cut portion, the screw element 5 can be screwed into the positioning assembly 3 until the resisting portion 50 resists against the part 4.

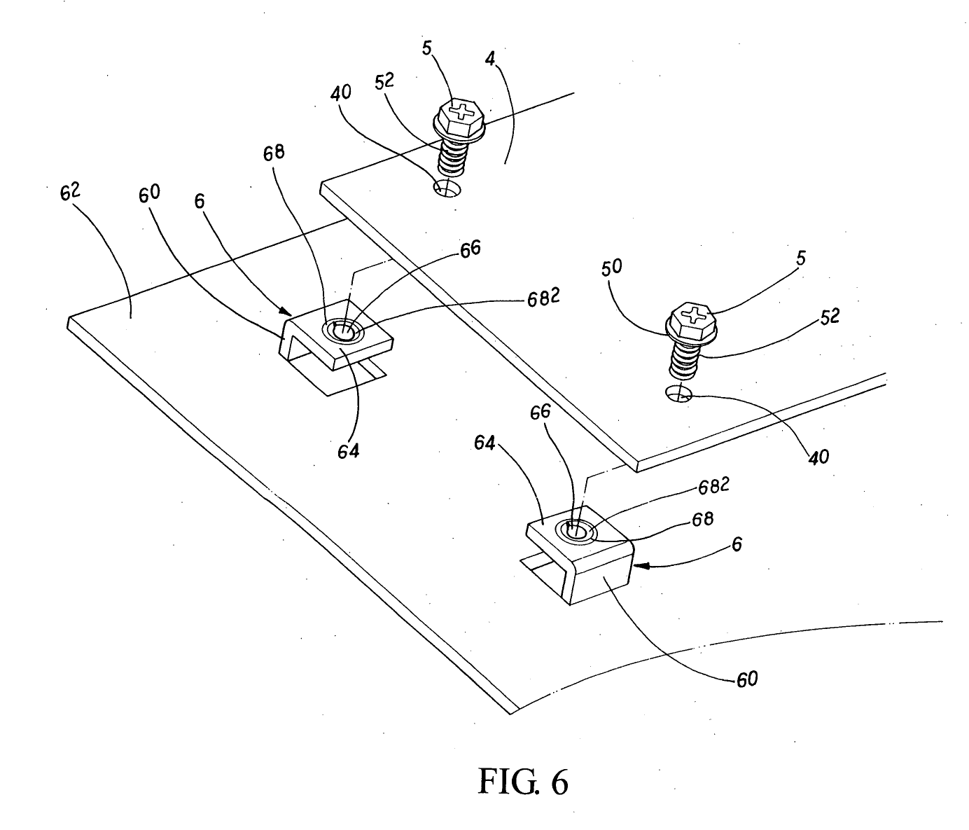

Referring to FIG. 6, another embodiment of the present invention is illustrated. In the following those identical to the first embodiment will not be described herein. Only those difference are described. The positioning assembly 6 has a top surface 64 connected to a lateral side 60. The top surface 64 and the lateral side 60 are formed as an L shape. The top surface 64 has an axial hole 66. A periphery of the axial hole 66 is formed with an annular shoulder 68. An inner edge of the shoulder 68 around the axial hole 66 is formed as an annular cut portion 682 which is an inclined surface with a lower edge near the axial hole 66 so as to guide a screw element 5 into the axial hole 66. The screw element 5 is aligned to the via hole 40 of a part 4 (for example a circuit board), then the screw element 5 can be locked into the positioning assembly 6.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A positioning assembly of a liquid crystal display; the positioning assembly being installed upon a bottom plate; the positioning assembly having a protrusion; one end surface of the protrusion having an axial hole; a periphery of the axial hole being formed with an annular shoulder; an inner side of the shoulder near the axial hole being formed with an annular cut portion for guiding a screw element into the axial hole.

2. The positioning assembly of a liquid crystal display as claimed in claim 1, wherein the positioning assembly is formed by punching.

3. The positioning assembly of a liquid crystal display as claimed in claim 1, wherein the annular cut portion is an inclined surface; and a lower edge of the inclined surface is near the axial hole.

4. The positioning assembly of a liquid crystal display as claimed in claim 1, wherein the protrusion has a tapered shape.

5. A positioning assembly of a liquid crystal display; the positioning assembly having a top surface and a lateral side which are formed as an approximate L shape, the lateral side installed upon a bottom plate; the top surface having an axial hole; a periphery of the axial hole being formed with an annular shoulder; an inner side of the shoulder near the axial hole being formed with an annular cut portion for guiding a screw element into the axial hole.

6. The positioning assembly of a liquid crystal display as claimed in claim 5, wherein the annular cut portion is an inclined surface; and a lower edge of the inclined surface is near the axial hole.
